(19) United States
(12) Patent Application Publication
(10) Pub. No.: US 2014/0058015 A1
(43) Pub. Date: Feb. 27, 2014

(54) INSERT MOLDED ARTICLE

(71) Applicants: Shinya Yamada, Shizuoka (JP); Kouichi Sakata, Shizuoka (JP); Fumiyuki Ohtake, Shizuoka (JP)

(72) Inventors: Shinya Yamada, Shizuoka (JP); Kouichi Sakata, Shizuoka (JP); Fumiyuki Ohtake, Shizuoka (JP)

(73) Assignee: Win Tech Polymer Ltd., Tokyo (JP)

(21) Appl. No.: 14/113,440

(22) PCT Filed: Apr. 25, 2012
(86) PCT No.: PCT/JP2012/061131

§ 371 Date: Nov. 14, 2013

(30) Foreign Application Priority Data
Apr. 26, 2011 (JP) 2011-098276

(51) Int. Cl. C08L 67/00

(52) U.S. Cl. CPC C08L 67/00
USPC 523/435

(57) ABSTRACT

Provided is an insert molded article provided with a resin member, which has superior heat shock resistance, flame resistance, and hydrolysis resistance, and an insert member. The insert molded article is provided with the insert member and resin member, and a polybutylene terephthalate resin composition in which a halogenated epoxy compound (B) having a specific molecular weight, an antimony oxide compound (C), and a carbodiimide compound (D) are mixed into a polybutylene terephthalate resin (A) is used for the starting material for the resin member. The specific molecular weight of component (B) is a number average molecular weight of 2,000-20,000.

### TECHNICAL FIELD

The present invention relates to an insert molded article including a resin member which is excellent in heat shock resistance, flame retardancy and hydrolysis resistance, and an insert member.

### BACKGROUND ART

A polybutylene terephthalate resin is used for various applications such as automobile components and electric/electronic components since it has various excellent properties such as mechanical properties, electrical properties, physical and chemical properties, and also has satisfactory processability. The polybutylene terephthalate resin is often used as a polybutylene terephthalate resin composition reinforced with fibrous fillers since heat resistance and strength can be improved by mixing fibrous fillers such as glass fibers.

As mentioned above, the polybutylene terephthalate resin has excellent properties, but has the drawback that it is likely to cause deterioration of physical properties due to hydrolysis because it is a polyester resin. Therefore, it is widely known that hydrolysis resistance is improved by mixing a carbodiimide compound into the polybutylene terephthalate resin.

As mentioned above, a polybutylene terephthalate resin composition having physical properties improved by mixing fibrous fillers or a carbodiimide compound is often used as a sensor used for electric control or a housing material of an engine control unit, particularly in the automobile field. In case a product used for such application is an insert molded article, the product is used in the environment exposed to sharp temperature rise and drop, such as an automobile engine room. Therefore, strain produced from a difference in linear expansion between a metal insert and a polybutylene terephthalate resin is likely to cause cracking. Accordingly, it is required for the product used for such application to have heat shock resistance which is less likely to cause cracking due to sharp difference in temperature. High flame retardancy may be sometimes required to the product used for such application.

In light of these circumstances, a study is made on suppression of the occurrence of cracking due to heat shock generated by sharp temperature rise and drop and, for example, a polybutylene terephthalate resin composition in which a carbodiimide compound is added, together with an acrylic rubber, an epoxy compound, a pentaerythritol ester and a fibrous reinforcer (Patent Document 1) is proposed.

Patent Document 1: Japanese Unexamined Patent Application, Publication No. S63-003055

### DISCLOSURE OF THE INVENTION

### Problems to be Solved by the Invention

However, in the polybutylene terephthalate resin composition disclosed in Patent Document 1, heat shock resistance and hydrolysis resistance are improved, while flame retardancy is still to be improved. Therefore, flame retardation of a polybutylene terephthalate resin composition containing a carbodiimide compound is required. However, eve when using a flame retardant such as brominated phthalimde in combination with a carbodiimide compound, desired improvement effect of heat shock resistance cannot be obtained. Even when using brominated polycarbonate in combination with a carbodiimide compound, high reactivity of the carbodiimide compound causes some side reaction, and thus failing to obtain desired improvement effect of heat shock resistance. As mentioned above, sufficient flame retardation of the polybutylene terephthalate resin composition containing a carbodiimide compound is still to be achieved.

The present invention has been made so as to solve the above-mentioned problems and an object thereof is to provide an insert molded article including a resin member which is excellent in heat shock resistance, flame retardancy and hydrolysis resistance, and an insert member.

### Means for Solving the Problems

The present inventors have intensively studied so as to achieve the above object. As a result, they have found that the above-mentioned problems can be solved by a resin member of an insert molded article comprising a polybutylene terephthalate resin composition in which a halogenated epoxy compound having a specific molecular weight, an antimony oxide compound and a carbodiimide compound are mixed into a polybutylene terephthalate resin, and thus completing the present invention. More specifically, the present invention provides the followings.

(1) An insert molded article including a resin member and an insert member, wherein the resin member comprises a polybutylene terephthalate resin composition containing a polybutylene terephthalate resin (A), a halogenated epoxy compound (B) having a number average molecular weight of 2,000 or more and 20,000 or less, an antimony oxide compound (C), and a carbodiimide compound (D).

(2) The metal insert molded article composed of a polybutylene terephthalate resin according to (1), wherein the halogenated epoxy compound (B) is a brominated epoxy compound represented by the following general formula (1).

[symbol]

(3) The insert molded article according to (1), wherein the halogenated epoxy compound (B) is a compound, both ends of which are capped with bromophenol, represented by the following general formula (2).

(4) The insert molded article according to any one of (1) to (3), wherein, in case the amount of a terminal carboxyl group of the polybutylene terephthalate resin (A) is 1 equivalent, the amount of a carbodiimide group of the carbodiimide compound (D) is 0.3 equivalent or more and 5.0 equivalents or less.

(5) The insert molded article according to any one of (1) to (4), wherein the amount of a terminal carboxyl group of the polybutylene terephthalate resin (A) is 30 meq/kg or less.

(6) The insert molded article according to any one of (1) to (5), further including a filler (E).

(7) The insert molded article according to (6), wherein the filler (E) is a glass fiber.

(8) The insert molded article according to any one of (1) to (7), further including an elastomer (F).

(9) The insert molded article according to (8), wherein the elastomer (F) is a grafted olefinic elastomer or a core-shell elastomer.

### Effects of the Invention

According to the present invention, since a resin member of an insert molded article comprises a polybutylene terephthalate resin composition in which a halogenated epoxy compound having a specific molecular weight, an antimony oxide compound and a carbodiimide compound are mixed, the resin member is excellent in heat shock resistance, flame retardancy and hydrolysis resistance.

### PREFERRED MODE FOR CARRYING OUT THE INVENTION

While embodiments of the present invention will be described in detail below, the present invention is not limited to the following embodiments and modifications can be made as appropriate without departing from the scope of the present invention. For the overlapping passages, a descriptions may be omitted appropriately, but it is not intended to limit the scope of the invention.

A polybutylene terephthalate resin (A), a halogenated epoxy compound (B), an antimony oxide compound (C), a carbodiimide compound (D), a filler (E), an elastomer (F), other components, an insert member, a method for producing a polybutylene terephthalate resin composition, and a method for producing an insert molded article will be described in order below.

[Polybutylene Terephthalate Resin (A)]

The polybutylene terephthalate resin (A) used in the polybutylene terephthalate resin composition is a polybutylene terephthalate resin obtained by polycondensing a dicarboxylic acid component containing at least terephthalic acid or an ester-forming derivative thereof (C₁-C₆ alkyl ester, acid halide, etc.) with a glycol component containing at least an alkylene glycol having 4 carbon atoms (1,4-butanediol) or an ester-forming derivative thereof. The polybutylene terephthalate resin is not limited to a homopolybutylene terephthalate resin and may be a copolymer including 60 mol % or more (particularly 75 mol % or more and 95 mol % or less) of a butylene terephthalate unit.

The amount of a terminal carboxyl group of the polybutylene terephthalate resin (A) used in the present invention is not particularly limited as long as the object of the present invention is not impaired. The amount of a terminal carboxyl group of the polybutylene terephthalate resin used in the present invention is preferably 30 meq/kg or less, and more preferably 25 meq/kg or less. When using a polybutylene terephthalate resin having a terminal carboxyl group in such amount, the obtained polybutylene terephthalate resin composition is particularly excellent in heat shock resistance, and is also much less likely to undergo a decrease in strength due to hydrolysis under wet heat environment.

The lower limit of the amount of a terminal carboxyl group of the polybutylene terephthalate resin (A) is not particularly limited but is preferably 10 meq/kg or more, and more preferably 5 meq/kg or more. When using a polybutylene terephthalate resin having a terminal carboxyl group in such amount, it is easy to prepare a polybutylene terephthalate resin composition which is excellent in heat shock resistance. It is generally difficult to produce a polybutylene terephthalate resin having a terminal carboxyl group in the amount of less than 5 meq/kg.

An inherent viscosity of the polybutylene terephthalate resin (A) used in the present invention is not particularly limited within a range not to impair the object of the present invention. The inherent viscosity (IV) of the polybutylene terephthalate resin (A) is preferably 0.60 dL/g or more and 1.2 dL/g or less. The inherent viscosity is more preferably 0.65 dL/g or more and 0.9 dL/g or less. When using a polybutylene terephthalate resin having an inherent viscosity within such range, the obtained polybutylene terephthalate resin composition is particularly excellent in moldability. It is also possible to adjust the inherent viscosity by blending polybutylene terephthalate resins each having a different inherent viscosity. For example, a polybutylene terephthalate resin having an inherent viscosity of 0.9 dL/g can be prepared by blending a polybutylene terephthalate resin having an inherent viscosity of 1.0 dL/g with a polybutylene terephthalate resin having an inherent viscosity of 0.7 dL/g. The inherent viscosity (IV) of the polybutylene terephthalate resin (A) can be measured, for example, in o-chlorophenol under the condition of a temperature of 35° C.

In the polybutylene terephthalate resin (A) used in the present invention, examples of the dicarboxylic acid component (comonomer component) other than terephthalic acid and an ester-forming derivative thereof include C₈-C₁₄ aromatic dicarboxylic acids such as isophthalic acid, phthalic acid, 2,6-naphthalenedicarboxylic acid and 4,4′-dicarboxydiphenyl ether; C₄-C₁₆ alkyldicarboxylic acids such as succinic acid, adipic acid, azelaic acid and sebacic acid; C₅-C₁₀ cycloalkyldicarboxylic acids such as cyclohexanedicarboxylic acid; and ester-forming derivatives (C₁-C₆ alkyl ester derivative, acid halide, etc.) of these dicarboxylic acid components. Theses dicarboxylic acid components can be used alone, or two or more dicarboxylic acid components can be used in combination.

Of these dicarboxylic acid components, C₈-C₁₂ aromatic dicarboxylic acids such as isophthalic acid; and C₆-C₁₂ alkyldicarboxylic acids such as adipic acid, azelaic acid and sebacic acid are more preferable.

In the polybutylene terephthalate resin used in the present invention, examples of the glycol component (comonomer component) other than 1,4-butanediol include C₂-C₁₀ alkylene glycols such as ethylene glycol, propylene glycol, trimethylene glycol, 1,3-butylene glycol, hexamethylene glycol, neopentyl glycol and 1,3-octanediol; polyoxyalkylene glycols such as diethylene glycol, triethylene glycol and dipropylene glycol; alicyclic diols such as cyclohexanedimethanol and hydrogenated bisphenol A; aromatic diols such as bisphenol A and 4,4′-dihydroxybiphenyl; C₂-C₄ alkylene oxide adducts of bisphenol A, such as an adduct of 2 mols of ethylene oxide to bisphenol A, and an adduct of 3 mols of propylene oxide to bisphenol A; or ester-forming derivatives (acetylated compound, etc.) of these glycols. These glycol components can be used alone, or two or more glycol components can be used in combination.

Of these glycol components, C₂-C₆ alkylene glycols such as ethylene glycol and trimethylene glycol; polyoxyalkylene glycol such as diethylene glycol; or alicyclic diols such as cyclohexanedimethanol, etc. are more preferable.

All of polybutylene terephthalate copolymers obtained by copolymerizing the above-described comonomer components can be suitably used as the polybutylene terephthalate resin (A). It is possible to use, as the polybutylene terephthalate resin (A), a homopolybutylene terephthalate polymer in combination with a polybutylene terephthalate copolymer.

The polybutylene terephthalate resin composition of the present invention contains, as a flame retardant, a halogenated epoxy compound (B). The polybutylene terephthalate resin composition of the present invention exerts a prominent improvement effect of heat shock resistance while imparting high flame retardancy to the polybutylene terephthalate resin composition by using a halogenated epoxy compound (B) in combination with the below-mentioned carbodiimide compound (D). Namely, the resin member of the insert molded article of the present invention is excellent in flame retardancy and is also excellent in heat shock resistance by a combination of the above-mentioned components. In case a combination of the carbodiimide compound (D) and a flame retardant other than the halogenated epoxy compound (B) is mixed into the polybutylene terephthalate resin, low improvement effect of heat shock resistance is exerted.

[Halogenated Epoxy Compound (B)]

The halogenated epoxy compound (B) contained in the polybutylene terephthalate resin composition has a number average molecular weight of 2,000 or more and 20,000 or less, and is also usable as the flame retardant. The number average molecular weight is preferably 3,000 or more and 15,000 or less, and more preferably 3,000 or more and 10,000 or less. In case the number average molecular weight is less than 2,000, an epoxy equivalent of the halogenated epoxy compound (B) may increase, and thus making it difficult to suppress deterioration of moldability due to a reaction with the polybutylene terephthalate resin. In case the number average molecular weight is more than 20,000, fluidity of the polybutylene terephthalate resin may decrease and it may become difficult to obtain the effect of heat shock resistance.

The halogenated epoxy compound (B) is preferably a brominated epoxy compound, and particularly preferably a poly(tetrabromo)bisphenol A type epoxy compound represented by the following formula (1).

[symbol]

It is also possible to use, as the above-mentioned halogenated epoxy compound, an end-capped compound. It is preferred to use an end-capped halogenated epoxy compound because of an increase in fluidity of the resin composition during molding. “Increase in fluidity” means that melt viscosity measured by the method disclosed in Example is 220 Pa·s or less.

Of end-capped halogenated epoxy compounds, end-capped brominated epoxy compound is preferable, and a bisphenol A type epoxy compound represented by the following formula (2) is particularly preferable. When using the end-capped halogenated epoxy compound, the resin member tends to be inferior in hydrolysis resistance and heat shock resistance as compared with the case of using a non end-capped halogenated epoxy compound. In the case of compound represented by the following general formula (2), these physical properties also have remarkably high values.

For end-capping, bromophenol is preferably used. Of bromophenol, tribromophenol is particularly preferably used.

[symbol]

x in the formula (2) is an integer of 1 or more and 5 or less.

The amount of the halogenated epoxy compound (B) used in the present invention is not particularly limited within a range not to impair the object of the present invention. The amount of the halogenated epoxy compound (B) used is preferably 10 parts by mass or more and 50 parts by mass or less, and more preferably 15 parts by mass or more and 40 parts by mass or less, based on 100 parts by mass of the polybutylene terephthalate resin (A). In case the amount of the halogenated epoxy compound (B) used is less than 10 parts by mass, desired flame retardancy may not be obtained. In case the amount is more than 50 parts by mass, mechanical properties such as tensile strength and bending strength may be likely to deteriorate, leading to deterioration of thermostability during melting. Use of the halogenated epoxy compound (B) in the amount within the above range enables preparation of a polybutylene terephthalate resin composition which is excellent in flame retardancy and heat shock resistance and is also excellent in mechanical properties. As a result, the resin member of the insert molded article of the present invention is excellent in flame retardancy, heat shock resistance and mechanical properties.

The halogenated epoxy compound is produced by using a known production method. The halogenated epoxy compound can be obtained, for example, by mixing tetrabromobisphenol A into tetrabromobisphenol A diglycidyl ether obtained by reacting tetrabromobisphenol A with epichlorohydrin such that the amount of the hydroxyl group becomes 0 to 0.96 equivalent based on 1 equivalent of the epoxy group, and reacting the mixture with heating at 100 to 250° C. in the presence of a basic catalyst, for example, sodium hydroxide, lithium hydroxide, tributylamine or the like.

[Antimony Oxide Compound (C)]

The polybutylene terephthalate resin composition contains, as a flame-retardant auxiliary, an antimony oxide compound (C). Examples of the antimony oxide compound (C) used in the present invention include antimony trioxide, antimony pentoxide or sodium antimonate.

The amount of the antimony oxide compound (C) used is not particularly limited within a range not to impair the object of the present invention. The amount of the antimony oxide compound (C) used is preferably 1 part by mass or more and 30 parts by mass or less, more preferably 2 parts by mass or more and 20 parts by mass or less, based on 100 parts by mass of the polybutylene terephthalate resin (A). In case the amount of the antimony compound (C) used is less than 1 part by mass, desired flame retardancy may not be obtained. In case the amount is more than 30 parts by mass, mechanical properties such as tensile strength and bending strength may be likely to deteriorate, leading to deterioration of heat shock resistance. Use of the antimony oxide compound (C) in the amount within such range enables preparation of a polybutylene terephthalate resin composition which is particularly excellent in flame retardancy.

[Carbodiimide Compound (D)]

The carbodiimide compound (D) used in the present invention is not particularly limited as long as it is a compound having a carbodiimide group (13 N=C=N—) in the molecule. In the carbodiimide compound (D) used in the present invention, a group bonded to a carbodiimide group is not particularly limited, and examples thereof include an aliphatic group, an alicyclic group, an aromatic group, or a group to which these organic groups are bonded (for example, benzyl group, phenethyl group, 1,4-xylylene group, etc.). Examples of the carbodiimide compound used suitably in the present invention include an aliphatic carbodiimide compound in which an aliphatic group is linked to a carbodiimide group, an alicyclic carbodiimide compound in which an alicyclic group is linked to a carbodiimide group, and an aromatic carbodiimide compound in which an aromatic group or a group including an aromatic group is linked to a carbodiimide group. These carbodiimide compounds (D) may be used alone, or two or more of these carbodiimide compounds may be used in combination.

Specific examples of the aliphatic carbodiimide compound include diisopropylcarbodiimide, dioctyldecylcarbodiimide and the like; and specific examples of the alicyclic carbodiimide compound include dicyclohexylcarbodiimide and the like.

Specific examples of the aromatic carbodiimide compound include mono- or dicarbodiimide compounds such as diphenylcarbodiimide, di-2,6-dimethylphenylcarbodiimide, N- tolyl-N′-phenylcarbodiimide, di-p-nitrophenylcarbodiimide, di- p-aminophenylcarbodiimide, di-p-hydroxyphenylcarbodiimide, di- p-chlorophenylcarbodiimide, di-p-methoxyphenylcarbodiimide, di-3,4-dichlorophenylcarbodiimide, di-2,5- chlorophenylcarbodiimide, di-o-chlorophenylcarbodiimide, p- phenylene-bis-di-o-tolylcarbodiimide, p-phenylene-bis-dicyclohexylcarbodiimide, p-phenylene-bis-di-chlorophenylcarbodiimide and ethylene-bis-diphenylcarbodiimide; and polycarbodiimide compounds such as poly(4,4′-diphenylmethanecarbodiimide), poly(3,5′-dimethyl- 4,4′-diphenylmethanecarbodiimide), poly(p- phenylenecarbodiimide), poly(m-phenylenecarbodiimide), poly(naphthylenecarbodiimide), poly(1,3- diisopropylphenylenecarbodiimide), poly(1-methyl-3,5- diisopropylphenylenecarbodiimide), poly(1,3,5-triethylphenylenecarbodiimide) and poly(triisopropylphenylenecarbodiimide).

In case the carbodiimide compound (D) is a polycarbodiimide compound, the molecular weight is preferably 2,000 or more. Use of the polycarbodiimide compound having such molecular weight enables suppression of the generation of a gas or odor during melt-kneading or molding.

Of these carbodiimide compounds (D), aromatic carbodiimide compounds such as di-2,6-dimethylphenylcarbodiimide, poly(4,4′-diphenylmethanecarbodiimide), poly(phenylenecarbodiimide) and poly(triisopropylphenylenecarbodiimide) are more preferable in view of stability of a carbodiimide group under wet heat environment, improvement effect of hydrolysis resistance and improvement effect of heat shock resistance.

The amount of the carbodiimide compound (D) used in the present invention is not particularly limited as long as the object of the present invention is not impaired. The amount of the carbodiimide compound (D) used is preferably the amount in which the amount of a carbodiimide group becomes 0.3 equivalent or more and 5.0 equivalents or less, and more preferably 0.5 equivalent or more and 3.0 equivalents or less, in case the amount of a terminal carboxyl group of the polybutylene terephthalate resin (A) is 1 equivalent.

In case the amount of the carbodiimide compound (D) used is too small, desired heat shock resistance may not be obtained. When the amount is too large, a gelled substance and a carbide may be likely to be produced during melt-kneading or molding, leading to deterioration of mechanical properties such as tensile strength and bending strength, a quick decrease in strength under wet heat environment, and a decrease in fluidity.

[Filler (E)]

The polybutylene terephthalate resin composition can contain, in addition to a polybutylene terephthalate resin (A), a halogenated epoxy compound (B), an antimony oxide compound (C) and a carbodiimide compound (D), a filler (E). It is possible to use, as the filler (E), various fillers such as fibrous fillers and non-fibrous fillers (granular and plate-shaped fillers) depending on the purposes. Two or more of these fillers can be used in combination.

Examples of the fibrous filler among these fillers include, but are not limited to, glass fiber, carbon fiber, potassium titanate fiber, silica-alumina fiber, zirconia fiber, silica fiber, boron nitride fiber, silicon nitride fiber, boron fiber, aluminum borate fiber, metal fiber, organic fiber and the like.

Examples of the granular filler include, but are not limited to, silicates such as silica, quartz powder, glass beads, glass powder, calcium silicate, kaolin, diatomaceous earth and wollastonite; metal oxides such as iron oxide, titanium oxide, zinc oxide and alumina; carbonates of metals, such as calcium carbonate and magnesium carbonate; sulfates of metals, such as calcium sulfate and barium sulfate; and silicon carbide, silicon nitride, boron nitride, various metal powders.

Examples of the plate-shaped filler include, but are not limited to, mica, glass flake and the like.

Of these fillers (E), fibrous fillers are more preferably used since the obtained polybutylene terephthalate resin composition is excellent in mechanical properties. Of fibrous fillers, glass fiber is preferably used in view of balance between improvement effect of mechanical properties and cost.

The glass fiber used in the present invention is not limited by the fiber diameter, cross-sectional shape (for example, circle, ovaloid, ellipse, etc.) and the like, and any known glass fiber can be preferably used. It is possible to use a glass fiber in various forms such as chopped strand, milled fiber and roving. In the present invention, type of glass composing the glass fiber is not particularly limited, and E glass and a corrosion-resistant glass containing a zirconium element are preferably used in terms of quality.

When using the filler (E) in the present invention, it is preferred to use a filler subjected to a surface treatment with an organic treating agent such as an aminosilane compound or an epoxy compound for the purpose of improving properties of the interface between a filler and a resin matrix. When using the filler subjected to a surface treatment with an organic treating agent, the amount of the organic treating agent used is preferably 0.03% by mass or more and 5% by mass or less, and more preferably 0.3% by mass or more and 2% by mass or less, based on the mass of the filler subjected to a surface treatment. The amount of the organic treating agent used can be known by measuring heating loss of the filler subjected to a surface treatment. In the present invention, the organic treating agent used in the surface treatment of the filler is not particularly limited, and it is possible to use various surface treatment agents which have conventionally been used in the surface treatment of the filler.

The amount of the filler (E) used in the polybutylene terephthalate resin composition of the present invention is not particularly limited within a range not to impair the object of the present invention. The amount of the filler (E) used is preferably 20 parts by mass or more and 100 parts by mass or less, more preferably 20 parts by mass or more and 90 parts by mass or less, and particularly preferably 30 parts by mass or more and 80 parts by mass or less, based on 100 parts by mass of the polybutylene terephthalate resin (A). It is possible to impart excellent heat shock resistance while improving mechanical properties and surface properties of the polybutylene terephthalate resin composition by adjusting the amount of the filler (E) used within such range.

[Elastomer (F)]

More preferably, the polybutylene terephthalate resin composition of the present invention contains, in addition to the above-mentioned polybutylene terephthalate resin (A), halogenated epoxy compound (B), antimony oxide compound (C) and carbodiimide compound (D), an elastomer (F). Higher improvement effect of heat shock resistance can be obtained by mixing the elastomer (F) into the polybutylene terephthalate resin composition. In case the elastomer (F) is mixed into the polybutylene terephthalate resin composition of the present invention, the above-mentioned filler (E) may be mixed, together with the elastomer (F).

As mentioned above, heat shock resistance can be remarkably enhanced by mixing of the elastomer. According to the present invention, it is possible to enhance heat shock resistance of the resin member as compared with that of a conventional one without mixing the elastomer. Mechanical properties of the resin member are remarkably enhanced in case the elastomer is not mixed.

Examples of suitable elastomer (F) usable in the present invention include a thermoplastic elastomer and a core-shell elastomer. Specific examples of the thermoplastic elastomer include grafted olefinic elastomers, styrene elastomers, polyester elastomers and the like.

The amount of the elastomer (F) used in the polybutylene terephthalate resin composition of the present invention is not particularly limited within a range not to impair the object of the present invention. The amount of the elastomer (F) used is preferably 5 parts by mass or more and 40 parts by mass or less, and more preferably 10 parts by mass or more and 30 parts by mass or less, based on 100 parts by mass of the polybutylene terephthalate resin (A). Particularly excellent heat shock resistance can be achieved by adjusting the amount of the elastomer (F) used within such range.

Grafted Olefinic Elastomer

The grafted olefinic elastomer which is suited for use as the elastomer (F) in the present invention includes a copolymer containing ethylene and/or propylene as main components, that is, a graft copolymer in which (a-1) an ethylene-unsaturated carboxylic acid alkyl ester copolymer, or (a-2) an olefinic copolymer composed of an α-olefin and a glycidyl ester of an α,β-unsaturated acid, and (b) one or more polymers or copolymers composed mainly of a repeating unit represented by the following formula (3) are chemically bonded in a branching or crosslinking structural manner.

[symbol]

R in the formula (3) represents a hydrogen atom or a C1-C6 alkyl group, and X represents one or more groups selected from the group consisting of —COOCH₃, —COOC₂H₅, —COOC₄H₉, —COOCH₂CH(C₂H₅)C₄H₉, a phenyl group and a cyano group.

Specific examples of the ethylene-unsaturated carboxylic acid alkyl ester copolymer (a-1) include random copolymers such as an ethylene-methyl acrylate copolymer, an ethylene-methyl methacrylate copolymer, an ethylene-ethyl acrylate copolymer and an ethylene-vinyl acetate-ethyl acrylate copolymer. The ethylene-unsaturated carboxylic acid alkyl ester copolymer (a-1) may be obtained by copolymerizing an unsaturated carboxylic acid such as acrylic acid or methacrylic acid within a range not to impair the object of the present invention. Two or more of these copolymers can be used in combination.

Examples of the α-olefin, which is one monomer composing the olefinic copolymer (a-2), include ethylene, propylene, 1-butene and the like. Of these, ethylene is more preferably used.

The glycidyl ester of an α,β-unsaturated acid, which is the other monomer composing the component (a-2), is a compound represented by the following formula (4), and examples thereof include an acrylic acid glycidyl ester, a methacrylic acid glycidyl ester, an ethacrylic acid glycidyl ester and the like. Of these glycidyl esters of the α,β-unsaturated acid, a methacrylic acid glycidyl ester is particularly preferably used.

R1 in the formula (4) represents a hydrogen atom or a C1-C6 alkyl group.

The olefinic copolymer composed of an α-olefin such as ethylene, and a glycidyl ester of an α,β-unsaturated acid can be obtained by copolymerizing an α-olefin with a glycidyl ester of an α,β-unsaturated acid through a radical polymerization reaction in accordance with a conventional method. In case a copolymer is produced, a suitable ratio of an α-olefin to a glycidyl ester of an α,β-unsaturated acid is 70% by mass or more and 99% by mass or less of an α-olefin/1% by mass or more and 30% by mass or less of a glycidyl ester of an α,β-unsaturated acid.

The polymer or copolymer (b), which is subjected to graft polymerization together with an olefinic copolymer (a-1) or (a-2), is a homopolymer composed only of one repeating unit represented by the formula (3), or a copolymer comprising two or more repeating units. Specific examples of the polymer or copolymer (b) include polymethyl methacrylate, polyethyl acrylate, polybutyl acrylate, (2-ethylhexyl) polyacrylate, polystyrene, polyacrylonitrile, acrylonitrile-styrene copolymer, butyl acrylate-methyl methacrylate copolymer, butyl acrylate-styrene copolymer and the like. Of these polymers or copolymers (b), a butyl acrylate-methyl methacrylate copolymer is particularly preferably used. These polymers or copolymers (b) can be prepared by radical polymerization of the corresponding vinyl monomer in accordance with a conventional method.

The graft copolymer used suitably in the present invention is a graft copolymer having a branching or crosslinking structure in which an olefinic copolymer (a-1) or (a-2) is chemically bonded with a polymer or copolymer (b) in at least one point. The graft copolymer has such branching or crosslinking structure, thereby, it is possible to obtain an excellent improvement effect of heat shock resistance as compared with the case of mixing an olefinic copolymer (a-1) or (a-2), or a polymer or copolymer (b) alone into a polybutylene terephthalate resin composition. A ratio of (a-1) or (a-2)/(b) composing a graft copolymer is preferably 95:5 to 5:95, and more preferably 80:20 to 20:80, in terms of a mass ratio.

Styrene Elastomer

It is suitably used, as the styrene elastomer used as the elastomer (F) in the present invention, a block copolymer comprising a polystyrene block, and an elastomer block of a polyolefin structure. Specific examples of the styrene elastomer include a styrene-isoprene-styrene block copolymer (SIS), a styrene-ethylene/propylene-styrene block copolymer (SEPS), a styrene-ethylene•butylene-styrene block copolymer (SEBS), a styrene-ethylene•ethylene/propylene-styrene block copolymer (SEEPS) and the like.

Core-Shell Elastomer

The core-shell elastomer used as the elastomer (F) in the present invention has a multilayer structure comprising a core layer (core portion) and a shell layer which covers at least one portion of a surface of the core layer. The core layer of the core-shell elastomer preferably comprises a rubber component (soft component), and an acrylic rubber is suitably used as the rubber component. The rubber component used in the core layer preferably has a glass transition temperature (Tg) of lower than 0° C. (for example, −10° C. or lower), more preferably −20° C. or lower (for example, −180° C. or higher and - 25° C. or lower), and particularly preferably −30° C. or lower (for example, −150° C. or higher and −40° C. or lower).

The acrylic rubber used as the rubber component is preferably a polymer obtained by polymerizing an acrylic monomer such as alkyl acrylate as a main component. The alkyl acrylate used as a monomer of the acrylic rubber is preferably a C₁-C₁₂ alkyl ester of acrylic acid, such as butyl acrylate, and more preferably a C₂-C₆ alkyl ester of acrylic acid.

The acrylic rubber may be either a homopolymer or a copolymer of an acrylic monomer. In case the acrylic rubber is a copolymer of an acrylic monomer, the copolymer may be either a copolymer of an acrylic monomer, or a copolymer of an acrylic monomer with the other unsaturated bond-containing monomer. In case the acrylic rubber is a copolymer, the acrylic rubber may be those obtained by copolymerizing a crosslinking monomer.

For the shell layer, a vinyl-based polymer is preferably used. The vinyl-based polymer is obtainable, for example, by polymerizing or copolymerizing at least one monomer selected from an aromatic vinyl monomer, a vinyl cyanide monomer, a methacrylic acid ester monomer and an acrylic acid ester monomer. The core layer and the shell layer of such core-shell elastomer may be bonded together by graft copolymerization. If necessary, graft copolymerization is achieved by adding a grafting agent, which reacts with a shell layer during polymerization of a core layer, to impart a reaction group to the core layer, and thus forming the shell layer. When using a silicone rubber as the grafting agent, organosiloxane having a vinyl bond or organosiloxane having thiol is used, and acryloxysiloxane, methacryloxysiloxane and vinylsiloxane are preferably used.

Polyester Elastomer

The polyester elastomer used as the elastomer (F) in the present invention is not particularly limited as long as it has bending elastic modulus of 1,000 MPa or less, and preferably 700 MPa or less, and various polyester elastomers can be used and either polyether or polyester type polyester elastomer can be used.

The polyether type polyester elastomer is a polyester elastomer which includes an aromatic polyester unit as a hard segment, and includes a polyester of a polymer of oxyalkylene glycol and dicarboxylic acid as a soft segment.

The aromatic polyester unit in the hard segment is a unit derived from a polycondensate of a dicarboxylic acid compound and a dihydroxy compound, a polycondensate of an oxycarboxylic acid compound, or a polycondensate of a dicarboxylic acid compound, a dihydroxy compound and an oxycarboxylic acid compound. Specific examples of the hard segment include a unit derived from polybutylene terephthalate.

The soft segment is introduced into a polyester elastomer by a compound formed by polycondensation of a polyalkylene ether with a dicarboxylic acid compound. Specific examples of the soft segment include a unit derived from an ester compound of polyoxytetramethylene glycol derived from tetrahydrofuran.

It is possible to use either a synthesized polyether type elastomer or a commercially available one. Examples of the commercially available product of the polyether type elastomer include PELPRENE P-30B, P-70B, P-90B and P-208B manufactured by TOYOBO CO., LTD.; Hytrel 4057, 4767, 6347 and 7247 manufactured by Du Pont-Toray Co., Ltd.; and Light Flex 655 manufactured by Ticona Inc.

The polyester type elastomer is a polyester elastomer which includes an aromatic polyester unit as a hard segment and an amorphous polyester unit as a soft segment. The aromatic polyester unit in the hard segment is the same as that of the polyether type elastomer. Examples of the amorphous polyester unit in the soft segment include a unit derived from a ring-opening polymer of lactone, or a polycondensate of an aliphatic dicarboxylic acid and an aliphatic diol.

It is possible to use either a synthesized polyester type elastomer or a commercially available one. Examples of the commercially available product of the polyester type elastomer include PELPRENE S-1002, S-2002 manufactured by TOYOBO CO., LTD., and the like.

[Other Components]

Depending on applications of a molded article, it may be required to have flame classification of UL-94 “V-0”. In that case, a dripping inhibitor such as a fluorine-based resin is preferably used in a polybutylene terephthalate resin composition, together with a flame retardant.

Examples of the fluorine-based resin suited for use as the dripping inhibitor include a homopolymer or copolymer of a fluorine-containing monomer such as tetrafluoroethylene, chlorotrifluoroethylene, vinylidene fluoride, hexafluoropropylene or perfluoroalkyl vinyl ether; and a copolymer of the above-mentioned fluorine-containing monomer with a copolymerizable monomer such as ethylene, propylene or (meth)acrylate. These fluorine-based resins can be used alone, or two or more of fluorine-based resins can be used in combination.

Examples of such fluorine-based resin include homopolymers such as polytetrafluoroethylene, polychlorotrifluoroethylene and polyvinylidene fluoride; and copolymers such as a tetrafluoroethylene-hexafluoropropylene copolymer, a tetrafluoroethylene-perfluoroalkyl vinyl ether copolymer, a ethylene-tetrafluoroethylene copolymer, and an ethylene-chlorotrifluoroethylene copolymer.

The amount of the fluorine-based resin added is preferably 10 parts by mass or less, more preferably, 0.1 part by mass or more and 5 parts by mass or less, and still more preferably 0.2 part by mass or more and 1.5 parts by mass or less, based on 100 parts by mass of the polybutylene terephthalate resin (A).

The polybutylene terephthalate resin composition of the present invention can include various additives such as antioxidants, heat stabilizers, ultraviolet absorbers, antistatic agents, dyes, pigments, lubricants, plasticizers, mold releasants, crystallization accelerators, nucleating agents and epoxy compounds depending on the purposes.

[Insert Member]

It is possible to use, as an insert member included in the insert molded article of the present invention, a general insert member which has conventionally been used in an insert molded article. Specifically, the insert member may be made of any one of metal, inorganic materials and organic materials. Examples of the material of the insert member include metals such as steel, cast iron, stainless steel, aluminum, copper, gold, silver and brass; and thermally conductive ceramics and carbon materials. It is also possible to use, as the material of the insert member, metals including a metal thin film formed on a surface. Examples of the metal thin film include a thin film formed by a plating treatment (wet plating treatment, dry plating treatment, etc.). Note that the material of the insert member may refer to not only metal, inorganic material alone, but also a composite including a plurality of metals, resins, or the like.

Regarding the material composing the insert member, for example, preferable material can be appropriately selected taking applications into consideration.

The molding method for producing an insert member is not particularly limited. In the case of metal, for example, an insert member having a desired shape can be produced by processing such as cutting using a conventionally known machine tool, or a method such as templet casting such as die cast, injection molding or stamping.

[Method for Producing Polybutylene Terephthalate Resin Composition]

The polybutylene terephthalate resin composition can be produced by various methods which have conventionally been known as a method for producing a thermoplastic resin composition. Examples of the suitable method as a method for producing a polybutylene terephthalate resin composition include a method in which the respective components are melt-kneaded using a melt kneader such as a single or twin-screw extruder to form extrusion pellets.

The carbodiimide compound (D) can also be mixed as a masterbatch containing a thermoplastic resin as a matrix. The masterbatch of the carbodiimide compound (D) is preferably masterbatch in which a polybutylene terephthalate resin is used as a matrix, but it is also possible to use those in which other thermoplastic resin such as a polyethylene terephthalate resin is used as a matrix.

In the polybutylene terephthalate resin composition, melt viscosity measured at a temperature of 260° C. and a shear rate of 1,000 sec⁻¹ in accordance with ISO11443 can be preferably adjusted to 300 Pa·s or less, and more preferably 250 Pa·s or less. Since the polybutylene terephthalate resin composition of the present invention exhibits such melt viscosity, it exhibits excellent fluidity during molding, and is less likely to cause molding defects such as shortshot.

[Method for Producing Insert Molded Article]

The insert molded article of the present invention can be produced by disposing an insert member on a die and injecting the polybutylene terephthalate resin composition into the die.

The thus obtained insert molded article of the present invention is suitably used for various applications such as insert parts since a resin member is excellent in heat shock resistance, flame retardancy and hydrolysis resistance. Particularly, even when exposed to sharp temperature rise and drop, heat shock is less likely to cause cracking, so that the insert molded article is suitably used as a material of an insert molded article of automobile applications.

### EXAMPLES

The present invention will be described in more detail below by way of Examples, but the present invention is not limited to these Examples.

### Examples 1 to 15 and Comparative Examples 1 to 7

In Examples 1 to 15, and Comparative Examples 1 to 7, the following materials were used as components of a polybutylene terephthalate resin composition.

[Polybutylene Terephthalate Resin (PBT)]
A-1: manufactured by WinTech Polymer Ltd. (inherent viscosity of 0.69, amount of terminal carboxyl group of 24 meq/kg)

[Flame Retardant]
B-1: Brominated epoxy compound [tetrabromobisphenol A-tetrabromobisphenol A glycidyl ether copolymer] (manufactured by Sakamoto Yakuhin Kogyo Co., Ltd., SR-T2000, bromine content of 52% by mass, number average molecular weight of 4,000, without end-cap)
B-2: Brominated epoxy compound [tetrabromobisphenol A-tetrabromobisphenol A glycidyl ether copolymer] (manufactured by Sakamoto Yakuhin Kogyo Co., Ltd., SR-T2040, bromine content of 54% by mass, number average molecular weight of 4,000, with end-cap)
B-3: Brominated epoxy compound [tetrabromobisphenol A-tetrabromobisphenol A glycidyl ether copolymer] (manufactured by Sakamoto Yakuhin Kogyo Co., Ltd., SR-T5000S, bromine content of 52% by mass, number average molecular weight of 10,000, without end-cap)
B-4: Brominated epoxy compound [tetrabromobisphenol A-tetrabromobisphenol A glycidyl ether copolymer] (manufactured by Sakamoto Yakuhin Kogyo Co., Ltd., SR-T20,000, bromine content of 52% by mass, number average molecular weight of 30,000, without end-cap)
B-5: Brominated epoxy compound [tetrabromobisphenol A-tetrabromobisphenol A glycidyl ether copolymer] (manufactured by ICL-IP JAPAN Ltd., F3100, bromine content of 55% by mass, number average molecular weight of 15,000, with end-cap)
B-6: Brominated polycarbonate (manufactured by Teijin Chemicals Ltd., Fire Guard 7500, bromine content of 52% by mass)
B-7: Brominated phthalimide (manufactured by ALBEMARLE JAPAN CORPORATION, SAYTEX BT93W, bromine content of 67% by mass)

[Antimony Compound]
C-1: Antimony trioxide (manufactured by Nihon Seiko Co., Ltd., PATOX-M)

[Carbodiimide Compound]
D-1: Aromatic carbodiimide (manufactured by Rhein Chemie Japan, STABAXOL P-400)
D-2: Aliphatic carbodiimide (manufactured by Nisshinbo Chemical Inc. CARBODILITE LA-1)

[Glass Fiber]
E-1: Glass fiber (manufactured by Nitto Boseki Co., Ltd., CS3J948S)

[Elastomer]
F-1: Grafted olefinic elastomer [ethylene/ethyl acrylate copolymer-graft-butyl acrylate/methyl methacrylate copolymer] (manufactured by NOF CORPORATION, MODIPER A5300)
F-2: Core-shell polymer [core: polybutyl acrylate, shell: glycidyl methacrylate-modified polymethyl methacrylate] (manufactured by Rohm And Haas Japan K K, PARALOID EXL2314)
F-3 (Polystyrene-poly(ethylene-ethylene/propylene) block polystyrene copolymer) manufactured by KURARAY CO., LTD., SEPTON 4055
F-4 (Polyester elastomer) manufactured by TOYOBO CO., LTD., PELPRENE P9OBD

[PTFE]
Polytetrafluoroethylene resin (manufactured by Asahi Glass Co., Ltd., Fluon CD-076)

[Plasticizer]
Pyromellitic acid mixed alcohol ester (manufactured by ADEKA Corporation, Adekacizer UL-100)

Components shown in Tables 1 and 2 were dry-blended at a ratio of the content (parts by mass) shown in Tables 1 and 2, and then the obtained dry blend was melt-kneaded using a twin-screw extruder (TEX-30, manufactured by The Japan Steel Works, Ltd.) under the conditions of a cylinder temperature of 260° C., an ejection amount of 15 kg/hr and a screw speed of 150 rpm to prepare pellets of a polybutylene terephthalate resin composition. Using the pellets thus obtained, a test specimen was produced, and then heat shock resistance, tensile strength, tensile elongation, bending strength, bending elastic modulus, Charpy impact strength, flame retardancy and hydrolysis resistance (pressure cooker test) of the polybutylene terephthalate resin composition were measured. The measurement results of the heat shock resistance, tensile strength, tensile elongation, bending strength, bending elastic modulus, Charpy impact strength, and flame retardancy of the polybutylene terephthalate resin compositions of Examples 1 to 15 are shown in Table 1, while the measurement results of the hydrolysis resistance are shown in Table 3. The measurement results of the heat shock resistance, tensile strength, tensile elongation, bending strength, bending elastic modulus, Charpy impact strength and flame retardancy of the polybutylene terephthalate resin compositions of Comparative Examples 1 to 7 are shown in Table 2, while the measurement results of the hydrolysis resistance are shown in Table 4. The respective physical properties of the polybutylene terephthalate resin composition were measured by the following methods.

Heat Shock Resistance

Using a die in which an iron core measuring 18 mm in length, 18 mm in width and 30 mm in height is inserted into a prism measuring 22 mm in length, 22 mm in width and 51 mm in height, a test specimen of an insert molded article was produced by injection molding such that a minimum wall thickness of some resin portion becomes 1 mm. Using a hot-cold shock testing equipment, the insert molded article thus obtained was subjected to a heat shock resistance test in which one cycle consists of the process of heating at 140° C. for 1 hour and a half, dropping the temperature to −40° C., cooling for 1 hour and a half, and raising the temperature to 140° C. Then, the number of cycles until the occurrence of cracking in the molded article was measured and heat shock resistance was evaluated. The test was performed up to 400 cycles.

Melt Viscosity

Melt viscosity was measured at a cylinder temperature of 260° C. and a shear rate of 1000 sec⁻¹ in accordance with IS01143.

Tensile Strength, and Tensile Elongation

Tensile strength and tensile elongation were measured in accordance with ISO527-1,2.

Bending Strength, and Bending Elastic Modulus

Bending strength and bending elastic modulus were measured in accordance with ISO178.

Charpy Impact Strength

Charpy impact strength was measured in accordance with IS0179/1eA.

Flame Retardancy

With respect to a test specimen (0.75 mm in thickness), flame retardancy was examined by carrying out the UL-94 vertical firing test of UNDERWRITERS LABORATORIES INC. Hydrolysis Resistance (Pressure Cooker Test)

Tensile test specimen (ISO3167) was produced by injection molding under the conditions of a resin temperature of 260° C., a mold temperature of 80° C., an injection time of 15 seconds, and a cooling time of 15 seconds, and then tensile strength and tensile elongation of the obtained test specimen were measured in accordance with IS0527-1,2. Using pressure cooker test equipment, the tensile test specimen was exposed for 25 hours, 50 hours and 75 hours under the conditions of 121° C. and 100% RH. After exposure, tensile strength and tensile elastic modulus of the test specimen were measured, and then a tensile strength retention ratio and a tensile elongation retention ratio of the test specimen after exposure to the test specimen before exposure were measured.

TABLE 1

| | | Ex- | Ex- | Ex- | Ex- | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|---|---|---|---|
| | | ample | ample | ample | ample | ample | ample | ample | ample | ample | ample | ample | ample | ample | ample | ample | ample |
| | | 1 | 2 | 3 | 4 | 5 | 6 | 7 | 8 | 9 | 10 | 11 | 12 | 13 | 14 | 15 | 16 |
| A: PBT | content | 100 | 100 | 100 | 100 | 100 | 100 | 100 | 100 | 100 | 100 | 100 | 100 | 100 | 100 | 100 | 100 |
| B: flame | type | B-1 | B-1 | B-1 | B-1 | B-1 | B-1 | B-1 | B-1 | B-1 | B-1 | B-2 | B-3 | B-5 | B-1 | B-1 | B-1 |
| retardant | content | 33.3 | 29 | 29.2 | 29 | 26.9 | 34.1 | 49.3 | 34.5 | 34 | 34.1 | 32.4 | 34.1 | 31.7 | 34.1 | 34.1 | 34.9 |
| C: | content | 12.8 | 11.2 | 11.4 | 11.2 | 9.8 | 12.4 | 13.8 | 12.6 | 12.4 | 12.4 | 12.3 | 12.4 | 12.2 | 12.4 | 12.4 | 12.6 |
| antimony | | | | | | | | | | | | | | | | | |
| oxide | | | | | | | | | | | | | | | | | |
| compound | | | | | | | | | | | | | | | | | |
| D: | type | D-1 | D-1 | D-1 | D-1 | D-1 | D-1 | D-1 | D-1 | D-2 | D-1 | D-1 | D-1 | D-1 | D-1 | D-1 | D-1 |
| carbodi- | content | 2.2 | 1.2 | 1.2 | 1.2 | 1 | 1.3 | 1.5 | 2.7 | 1.1 | 1.3 | 1.3 | 1.3 | 1.3 | 1.3 | 1.3 | 4 |
| imide | | | | | | | | | | | | | | | | | |
| compound | | | | | | | | | | | | | | | | | |
| E: filler | content | 64.1 | 71.3 | 73 | 71.3 | 62.7 | 79.3 | 88.3 | 80.4 | 79.1 | 79.3 | 78.3 | 79.3 | 77.9 | 79.3 | 79.3 | 80.4 |
| F: | type | | F-1 | F-1 | F-2 | — | F-1 | F-1 | F-1 | F-1 | F-2 | F-1 | F-1 | F-1 | F-3 | F-4 | F-1 |
| elastomer | content | | 22.3 | 29.2 | 22.3 | | 26.4 | 29.3 | 26.8 | 26.4 | 26.4 | 26.1 | 26.4 | 26 | 26.4 | 26.4 | 26.8 |
| PTFE | content | 1.3 | 1.2 | 1.2 | 1.2 | 1 | 1.3 | 1.5 | 1.3 | 1.3 | 1.3 | 1.3 | 1.3 | 1.3 | 1.3 | 1.3 | 1.3 |
| plasticizer | content | | | | | 6.3 | 7.9 | 8.8 | 8 | 7.9 | 7.9 | 7.8 | 7.9 | 7.8 | 7.9 | 7.9 | 8 |
| equivalent | equiv- | 2.8 | 1.5 | 1.6 | 1.5 | 1.2 | 1.7 | 2 | 3.6 | 1.9 | 1.7 | 1.7 | 1.7 | 1.7 | 1.7 | 1.7 | 5.2 |
| of | alent | | | | | | | | | | | | | | | | |
| carbodi- | | | | | | | | | | | | | | | | | |
| imide | | | | | | | | | | | | | | | | | |
| group *1 | | | | | | | | | | | | | | | | | |
| bromide | wt % | 8.4 | 6.6 | 6.6 | 6.6 | 6.7 | 6.7 | 8.7 | 6.7 | 6.7 | 6.7 | 6.7 | 6.7 | 6.7 | 6.7 | 6.7 | 6.7 |
| content | | | | | | | | | | | | | | | | | |
| heat shock | times | 185 | 200 | 230 | 178 | 170 | 400<*² | 400<*² | 400<*² | 227 | 341 | 286 | 315 | 280 | 310 | 230 | 400<*² |
| resistance | | | | | | | | | | | | | | | | | |
| melt | Pa · s | 270 | 273 | 289 | 292 | 252 | 255 | 298 | 312 | 268 | 296 | 207 | 243 | 214 | 305 | 283 | 382 |
| viscosity | | | | | | | | | | | | | | | | | |
| tensile | MPa | 152 | 107 | 98 | 111 | 153 | 102 | 105 | 100 | 101 | 101 | 101 | 100 | 100 | 92 | 108 | 96 |
| strength | | | | | | | | | | | | | | | | | |
| tensile | % | 2.1 | 2.6 | 3 | 2.5 | 2.3 | 2.4 | 2.5 | 2.6 | 2.6 | 2.6 | 2.2 | 2.3 | 2.2 | 2.9 | 2.5 | 2.8 |
| elongation | | | | | | | | | | | | | | | | | |
| bending | MPa | 208 | 171 | 165 | 178 | 210 | 146 | 148 | 145 | 146 | 163 | 143 | 148 | 148 | 149 | 174 | 143 |
| strength | | | | | | | | | | | | | | | | | |
| bending | MPa | 10572 | 8607 | 8052 | 9156 | 10920 | 8815 | 8942 | 8908 | 8677 | 8756 | 8710 | 8679 | 8676 | 8042 | 8842 | 8796 |
| modulus | | | | | | | | | | | | | | | | | |
| Charpy | kJ/m² | 8.7 | 9.2 | 11.2 | 11 | 9.1 | 9.1 | 9 | 9.2 | 9.9 | 10.1 | 8.9 | 9.3 | 9.3 | 11 | 8.9 | 9.2 |
| impact | | | | | | | | | | | | | | | | | |
| strength | | | | | | | | | | | | | | | | | |
| flame | | V-0 | V-0 | V-0 | V-0 | V-0 | V-0 | V-0 | V-0 | V-0 | V-0 | V-0 | V-0 | V-0 | V-0 | V-0 | V-0 |
| retardancy | | | | | | | | | | | | | | | | | |

*1: equivalent of carbodiimide group in carbodiimide compound to amount of terminated carboxyl group of PBT
*2: “400<” means that cracking was not observed in a heat shock resistance test for up to 400 cycles.

TABLE 2

| | | Comparative | Comparative | Comparative | Comparative | Comparative | Comparative | Comparative |
|---|---|---|---|---|---|---|---|---|
| | | Example | Example | Example | Example | Example | Example | Example |
| | | 1 | 2 | 3 | 4 | 5 | 6 | 7 |
| A: PBT | content | 100 | 100 | 100 | 100 | 100 | 100 | 100 |
| B:flame retardant | type | B-3 | B-3 | B-1 | B-1 | B-4 | B-6 | B-7 |
| | content | 25.7 | 28.6 | 26.7 | 33.6 | 34.1 | 34.1 | 24.6 |
| C:antimony oxide compound | content | 8.9 | 11 | 9.7 | 12.3 | 12.4 | 12.4 | 11.5 |
| D:carbodiimide compound | type | | | | | D-1 | D-1 | D-1 |
| | content | | | | | 1.3 | 1.3 | 1.2 |
| E: filler | content | 57.9 | 70.4 | 62.1 | 78.3 | 79.3 | 79.3 | 73.7 |
| F: elastomer | content | | F-1 | | F-1 | F-1 | F-1 | F-1 |
| | | | 23.5 | | 26.1 | 26.4 | 26.4 | 24.6 |
| PTFE | content | 0.6 | 1.2 | 1 | 1.3 | 1.3 | 1.3 | 1.2 |
| plasticizer | content | | | 6.2 | 7.8 | 7.9 | 7.9 | 7.4 |
| equivalent of carbodiimide | equivalent | — | — | — | — | 1.7 | 1.7 | 1.7 |
| group/amount of terminal | | | | | | | | |
| carboxyl group of PBT *1 | | | | | | | | |
| bromide content | wt % | 7 | 6.6 | 6.7 | 6.7 | 6.7 | 6.7 | 6.7 |
| heat shock resistance | times | <20 *3 | 110 | 63 | 98 | 52 | 88 | 83 |
| melt viscosity | Pa · s | 189 | 260 | 240 | 235 | 274 | 255 | 215 |
| tensile strength | MPa | 151 | 115 | 147 | 109 | 91 | 95 | 97 |
| tensile elongation | % | 2 | 2.5 | 2.3 | 2.1 | 1.7 | 1.7 | 1.9 |
| bending strength | MPa | 211 | 181 | 203 | 169 | 140 | 138 | 144 |
| bending modulus | MPa | 10700 | 9205 | 10970 | 8882 | 9191 | 8517 | 8606 |
| Charpy impact strength | kJ/m² | 8.5 | 10.5 | 9.3 | 9.6 | 9.1 | 9.1 | 9 |
| flame retardancy | | V-0 | V-0 | V-0 | V-0 | V-0 | V-0 | V-0 |

*3 “<20” means that cracking occured in a heat shock resistance test of less than 20 cycles.

TABLE 3

| | | Ex- | Ex- | Ex- | Ex- | Ex- | Ex- | Ex- | Ex- | Ex- | Ex- | Ex- | Ex- | Ex- | Ex- | Ex- | Ex- |
|---|---|---|---|---|---|---|---|---|---|---|---|---|---|---|---|---|---|
| | | ample | ample | ample | ample | ample | ample | ample | ample | ample | ample | ample | ample | ample | ample | ample | ample |
| | | 1 | 2 | 3 | 4 | 5 | 6 | 7 | 8 | 9 | 10 | 11 | 12 | 13 | 14 | 15 | 16 |
| tensile | 25 hr | 90% | 95% | 95% | 93% | 90% | 95% | 95% | 95% | 94% | 95% | 91% | 92% | 94% | 93% | 87% | 96% |
| strength | 50 hr | 81% | 92% | 92% | 90% | 78% | 86% | 88% | 92% | 85% | 93% | 77% | 80% | 75% | 91% | 84% | 94% |
| retention | 75 hr | 63% | 86% | 88% | 84% | 60% | 80% | 85% | 90% | 79% | 86% | 62% | 65% | 61% | 83% | 75% | 93% |
| ratio | | | | | | | | | | | | | | | | | |
| tensile | 25 hr | 84% | 90% | 90% | 88% | 83% | 70% | 75% | 92% | 62% | 92% | 70% | 70% | 70% | 92% | 89% | 95% |
| elongation | 50 hr | 70% | 78% | 81% | 75% | 68% | 60% | 66% | 85% | 48% | 73% | 48% | 58% | 49% | 71% | 68% | 89% |
| retention | 75 hr | 44% | 76% | 79% | 61% | 45% | 46% | 50% | 80% | 33% | 59% | 35% | 43% | 37% | 60% | 51% | 86% |
| ratio | | | | | | | | | | | | | | | | | |

TABLE 4

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 6 | Example 6 | Example 7 |
| tensile | 25 hr | 83% | 90% | 85% | 89% | 87% | 90% | 91% |
| strength | 50 hr | 55% | 80% | 53% | 72% | 75% | 78% | 80% |
| retention ratio | 75 hr | 31% | 65% | 32% | 53% | 57% | 61% | 68% |
| tensile | 25 hr | 73% | 82% | 75% | 78% | 74% | 80% | 84% |
| elongation | 50 hr | 49% | 62% | 51% | 58% | 59% | 62% | 67% |
| retention ratio | 75 hr | 28% | 49% | 29% | 32% | 50% | 51% | 52% |

As is apparent from the results shown in Table 1 to Table 4, in the case of using, as the material of a resin member of an insert molded article, each of the polybutylene terephthalate resin compositions of Examples 1 to 15 in which a brominated epoxy compound, an antimony oxide compound, and a carbodiimide compound are mixed into a polybutylene terephthalate resin, the obtained resin member is excellent in heat shock resistance, flame retardancy and hydrolysis resistance, and also mechanical properties thereof are not impaired.

1. An insert molded article comprising a resin member and an insert member, wherein the resin member comprises a polybutylene terephthalate resin composition containing a polybutylene terephthalate resin (A), a halogenated epoxy compound (B) having a number average molecular weight of 2,000 or more and 20,000 or less, an antimony oxide compound (C), and a carbodiimide compound (D).

2. The metal insert molded article composed of a polybutylene terephthalate resin according to claim 1, wherein the halogenated epoxy compound (B) is a brominated epoxy compound represented by the following general formula (1).

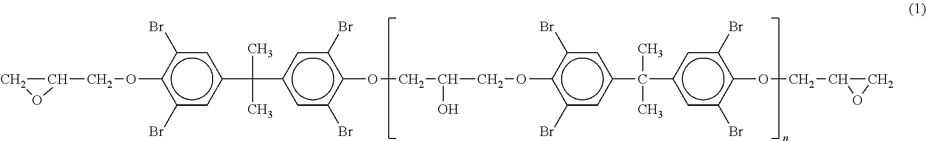

3. The insert molded article according to claim 1, wherein the halogenated epoxy compound (B) is a compound, both ends of which are capped with bromophenol, represented by the following general formula (2): 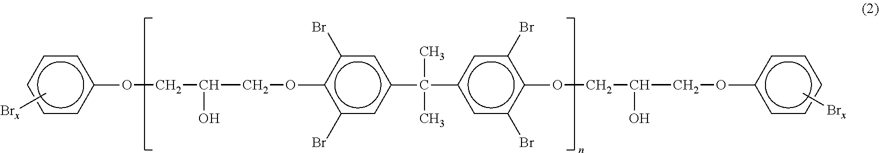
wherein x in the formula (2) is an integer of 1 or more and 5 or less.

4. The insert molded article according to claim 1, wherein, in case the amount of a terminal carboxyl group of the polybutylene terephthalate resin (A) is 1 equivalent, the amount of a carbodiimide group of the carbodiimide compound (D) is 0.3 equivalent or more and 5.0 equivalents or less.

5. The insert molded article according to claim 1, wherein the amount of a terminal carboxyl group of the polybutylene terephthalate resin (A) is 30 meq/kg or less.

6. The insert molded article according to claims 1, further comprising a filler (E).

7. The insert molded article according to claim 6, wherein the filler (E) is a glass fiber.

8. The insert molded article according to claim 1, further comprising an elastomer (F).

9. The insert molded article according to claim 8, wherein the elastomer (F) is a grafted olefinic elastomer or a core-shell elastomer.
